(19) United States
(12) Patent Application Publication
(10) Pub. No.: US 2019/0184533 A1
(43) Pub. Date: Jun. 20, 2019

(54) TOOL FOR PULLING IN A FASTENER

(71) Applicant: Airbus Operations GmbH, Hamburg (DE)

(72) Inventors: Jörn Skirke, Hamburg (DE); Wolfgang Papendick, Hamburg (DE)

(21) Appl. No.: 16/212,188

(22) Filed: Dec. 6, 2018

(30) Foreign Application Priority Data
Dec. 18, 2017 (DE) 10 2017 130 306.5

(51) Int. Cl. B25B 27/02

(52) U.S. Cl. CPC B25B 27/02

(57) ABSTRACT

A tool for pulling a fastener into a through opening, which is formed in two or more superposed parts to be joined, comprising: a main body, which has a supporting surface for supporting the tool on a surface of one part to be joined, and a pulling body for moving the fastener relative to the main body, wherein the pulling body can be moved from a first into a second position relative to the main body in a pulling direction perpendicular to the supporting surface, and a clamping device, formed on the pulling body, for clamping an outer section of the fastener, which projects beyond the opening in one part to be joined, wherein the extent of the main body perpendicular to the supporting surface, and the path of movement of the pulling body are shorter than four times the clamping clearance of the clamping device.

### CROSS-REFERENCES TO RELATED APPLICATIONS

This application claims the benefit of the German patent application No. 10 2017 130 306.5 filed on Dec. 18, 2017, the entire disclosures of which are incorporated herein by way of reference.

### FIELD OF THE INVENTION

The invention relates to the technical field of joining or connecting structural components in aircraft construction, in particular, the tools provided for this purpose. A joining or connecting process of this kind takes place in aircraft manufacture, in particular, also in final assembly lines (FAL).

### BACKGROUND OF THE INVENTION

In structural assembly, various fasteners, e.g., various rivets or bolts, are used or installed in order to connect different structural elements to one another permanently. In principle, these can be the “primary” structure or the “secondary” structure of the aircraft. Here, the fasteners or fastening means are arranged in several rows adjacent to one another, for example, in bores that are provided for this purpose and have been introduced in advance. A conventional example of the use of such fasteners is the construction and assembly of fuselage sections by means of a plurality of fuselage shells.

In order to achieve the connection between the corresponding parts to be joined or structural parts (e.g., two fuselage shells), the fasteners, in particular rivets, are typically hammered for further processing into the previously produced rivet or bolt holes in the structure to be connected by means of a hammer and, in some circumstances, a dolly. The noise emissions which arise indirectly during this process because of the hammering and which are partially amplified by the structural elements may be perceived as unpleasant by the workers carrying out this work.

As an alternative to hammering in, existing pull-in tools, e.g., the tool known from U.S. Pat. No. 5,526,669A, can be used. However, the disadvantage with this tool is that the extent of the tool in the axial direction of the fastener means that there is a relatively large space requirement for its use, space which, depending on the application, is not always available in aircraft construction and thus restricts its use. Moreover, only fasteners which have an internal thread can be included here.

Furthermore, U.S. Pat. No. 6,601,277 discloses a pulling tool by means of which a rivet head of an existing riveted joint can be pulled off by lateral engagement of a gripping element in order to separate the existing riveted joint. The pulling tool is used to remove rivets and not to pull them into a drill hole.

U.S. Pat. No. 3,727,491 furthermore shows a tool for removing a bolt from a hole, for which purpose corresponding internal and external threads are provided in the tool and the bolt.

Finally, CN200945602 likewise discloses a tool for removing a bolt from a hole. Here, gripping is likewise performed by means of gripping arms, which engage in a radial direction under a bolt head before the bolt is removed by axial pulling.

Given this background situation, it is an object of the present invention to make available a less noisy alternative to the known process of hammering in fasteners and to make available a tool which allows more practical handling with respect to its dimensions.

### SUMMARY OF THE INVENTION

An object of the invention is achieved by a tool for pulling a fastener into a through opening, which is formed in at least two or more superposed parts to be joined, comprising a main body, which has a supporting surface for supporting the tool on a surface of one part to be joined, and a pulling body for moving the fastener relative to the main body, wherein the pulling body can be moved from a first into a second position relative to the main body in a pulling direction perpendicular to the supporting surface, and a clamping device, formed on the pulling body, for clamping an outer section of the fastener, which projects beyond the through opening in one part to be joined, wherein the extent of the main body perpendicular to the supporting surface, and the path of movement of the pulling body are shorter than four times the clamping clearance of the clamping device.

The significant advantage of the tool according to the invention is that it allows an alternative installation method to the previously known process of hammering in the fastener in order to pull a fastener into a through opening with little noise or even without noise emissions. For this purpose, all that is required is to position the at least two parts to be joined relative to one another in such a way that the through opening is formed, then to place the tool on a surface of the part to be joined by way of its supporting surface, then to push the fastener at least partially through the through opening, and furthermore to clamp an outer section of the fastener, which projects beyond the through opening in one part to be joined, by means of the clamping device, and, finally, to pull the fastener in by moving the pulling body. The fastener pulled into the through opening can then be processed further for the intended purpose.

Another significant advantage of the tool according to the invention comprises that, by virtue of the limitation of the vertical extent to four times the clamping clearance of the clamping device, it can also be used in areas to which access is limited by the size of the installation space available. In other words: the tool according to the invention can also be used in narrow or restricted areas without significant limitations.

The fastener or at least a section of the fastener is generally of circular-cylindrical design. The fastener can be a rivet, a bolt, a screw or some other fastener, for example. It is self-evident that, in principle, the through opening can be formed in two or more parts to be joined. Accordingly, the tool can also be used to pull the fastener into a correspondingly formed through opening in the case of a plurality of parts to be joined.

According to the invention, the “clamping clearance” is taken to mean the clearance between the clamps or clamping surfaces when the fastener is clamped in the clamping device. The clamping clearance thus corresponds substantially to the outside diameter of the fastener to be pulled in. In the present case, “perpendicular to the supporting surface” is furthermore taken to mean the direction substantially orthogonal to the supporting surface. The through opening is typically a hole or a drill hole which is formed in the parts to be joined (generally introduced in advance).

A preferred embodiment is characterized in that the clamping device comprises a clamping element having a clamping surface for resting on the outer section of the fastener, wherein the clamping element is mounted in such a way as to be movable relative to the pulling body in a plane extending parallel to the supporting surface of the main body. By virtue of the mobility of the clamping element in the plane extending parallel to the supporting surface of the main body, the clamping force can typically be applied orthogonally to the outer section of the fastener and particularly effective clamping is achieved. In this embodiment, it is possible for the tool to have a single clamping element which is movable in an appropriate manner. That is to say, it is possible for the tool according to this embodiment to comprise just a single active clamping element. The clamping device can then have at least one further (passive) clamping surface, on which the outer section of the fastener can likewise come to rest. The tool according to this embodiment advantageously comprises a small number of moving or active elements and consequently has little susceptibility to faults.

In an embodiment which is likewise preferred, the clamping device comprises two clamping elements, each having a clamping surface for resting on the outer section of the fastener, wherein the clamping elements are mounted in such a way as to be movable towards one another and away from one another in a plane extending parallel to the supporting surface of the main body. In this way, a symmetrical construction of the tool is advantageously possible, allowing easier positioning of the tool on the fastener to be pulled in. In particular, it is possible, by means of a tool according to this embodiment, to place the tool without significant subsequent lateral displacement on one part to be joined, thus enabling the fastener to be pulled in easily.

In a preferred development of the preceding embodiment, to accommodate the outer section of the fastener, the pulling body has a unilaterally open recess with two mutually opposite flanks extending obliquely to one another in a V shape, wherein the two clamping elements of the clamping device each have a contact side for resting on one of the two flanks of the pulling body, wherein the two clamping elements of the clamping device are connected integrally to one another and are designed in such a way as to be, at least in part, elastically deformable relative to one another, and wherein the clamping surfaces are formed parallel to one another on opposite inner sides of the clamping elements. In the case of the tool designed in accordance with this embodiment, the clamping effect is made possible in a simple and effective manner by the clamping elements connected integrally to one another and designed to be at least in part elastically deformable relative to one another. For this purpose, it is possible, for example, to pull on a connection point of the two elastic clamping elements, in the plane extending parallel to the supporting surface, with the result that the contact sides of the clamping elements are displaced or slide past one another along the flanks of the pulling body. Owing to the V-shaped arrangement of the flanks, this then has the effect that the parallel clamping surfaces formed on the inner sides of the clamping elements move together. Conversely, pressing on this connection point in the same plane can have the effect that the contact sides of the clamping elements are pushed or slide past each other along the flanks of the pulling body in the opposite direction, this in turn having the effect that the clamping surfaces arranged parallel to one another move apart. Overall, an effective clamping mechanism is thus made available.

Furthermore, an embodiment is preferred in which the pulling body is hydraulically movable relative to the main body, and the clamping elements are hydraulically movable relative to the pulling body. By means of the hydraulic movability, it is possible in an advantageous way to achieve relatively high forces for pulling in the fastener. This is advantageous particularly in the case of relatively large fasteners or in the case of relatively large fastener diameters.

An embodiment of the tool is also preferred in which the pulling body is pneumatically movable relative to the main body, and the clamping elements are pneumatically movable relative to the pulling body. In the case of pneumatic movability, the many sources of pneumatic media that are generally already available in production lines can be used in an advantageous manner without investing significant further installation outlay. This thus makes the use of the tool according to the invention easier. It is self-evident that, in principle, pneumatic means can also be coupled with hydraulic means. For example, a pneumatic cylinder of relatively large design can be provided, which drives a relatively small hydraulic cylinder.

As a particular preference, the pulling body is electrically movable relative to the main body, and the clamping elements are electrically movable relative to the pulling body. With electric movability of the pulling body relative to the main body or of the clamping element relative to the pulling body, there is the advantage that rapid and selective control or easy controllability and thus also automation are possible. A small hydraulic pump can also be driven by means of a cordless screwdriver.

As a very particular preference, the main body and the pulling body and the clamping device are of U-shaped design. In this way, the tool according to the invention can be inserted laterally in a simple manner when the fastener is already partially projecting through the hole or opening. Handling is thus very convenient. A horseshoe-shaped or even a V-shaped configuration can count as a U-shaped design, for example.

Finally, a tool is preferred in which the extent of the main body perpendicular to the supporting surface, and the path of movement of the pulling body are shorter than four times the clamping clearance and longer than twice the clamping clearance. Tools according to the invention with such an extent or with such a path of movement have proven particularly practical in terms of handling.

The object is likewise achieved by a method for pulling a fastener into a through opening by means of a tool according to the invention, comprising the following steps: positioning the at least two parts to be joined relative to one another in such a way that the through opening is formed, placing the tool on a surface of one part to be joined by way of the supporting surface, pushing the fastener at least partially through the through opening, clamping an outer section of the fastener, which projects beyond the through opening in one part to be joined, by means of the clamping device, pulling the fastener in by moving the pulling body. The method according to the invention essentially makes use of the same advantages as the tool according to the invention.

The aspects described above and further aspects, features and advantages of the invention can likewise be inferred from the examples of the embodiment which is described below with reference to the attached drawings.

### BRIEF DESCRIPTION OF THE DRAWINGS

In the figures, identical reference signs are used for identical or at least similar elements, components or aspects. It is observed that an embodiment described in detail below is merely illustrative and not restrictive. In the claims, the word “having” does not exclude other elements, and the indefinite article “a” or “an” does not exclude a plurality. The mere fact that certain features are mentioned in various dependent claims does not restrict the subject matter of the invention. Combinations of these features can also be employed to advantage. The reference signs in the claims are not intended to restrict the scope of the claims. The figures should not be interpreted as being to scale but are of a merely schematic and illustrative character. In the drawing:

FIG. 1 shows a plan view of a tool according to the invention, which is placed on a surface of a part to be joined and placed against a fastener,

FIG. 2 shows a cross section along section line A-A in FIG. 1 through the tool according to the invention and the two parts to be joined, wherein the fastener is in a first position,

FIG. 3 shows a cross section along section line A-A in FIG. 1 through the tool according to the invention and the two parts to be joined, wherein the fastener is in the first position and the clamping device 28 is resting against the fastener,

FIG. 4 shows a cross section along section line A-A in FIG. 1 through the tool according to the invention and the two parts to be joined, wherein the fastener is in a second position,

FIG. 5 shows a cross section along section line A-A in FIG. 1 through the tool according to the invention and the two parts to be joined, wherein the fastener is in a third position,

FIG. 6 shows a cross section along section line A-A in FIG. 1 through the tool according to the invention and the two parts to be joined, wherein the fastener is in the third position, and

FIG. 7 shows a flow diagram of a method according to the invention for pulling a fastener into a through opening.

### DETAILED DESCRIPTION OF THE PREFERRED EMBODIMENTS

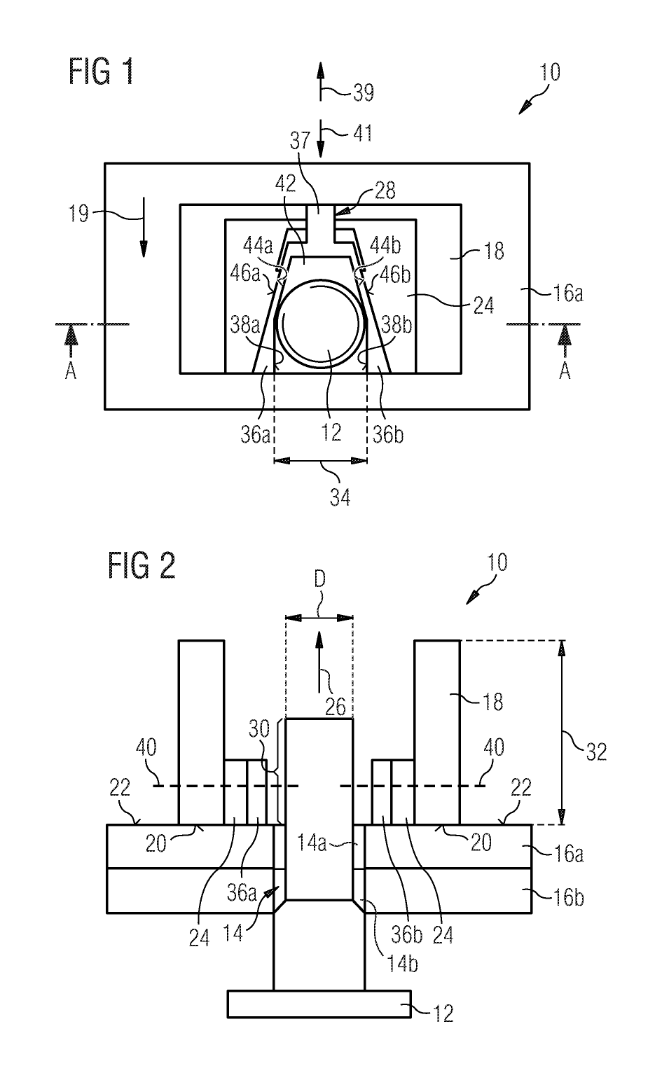

FIGS. 1 and 2 show a tool 10, which is suitable for pulling a fastener 12 into a through opening 14. The through opening 14 is formed by two superposed parts to be joined 16a, 16b, in each of which bores or through openings 14a, 14b are provided. In FIG. 1, the tool 10 is illustrated in a plan view, whereas FIG. 2 shows a cross section through the tool 10, the fastener 12 and the two parts to be joined 16a, 16b. In FIG. 2, the fastener 12 is in a first position, in which the fastener 12 has been introduced at least partially into the through opening 14, with the result that an outer section 30 of the fastener 12 projects at least partially beyond the through opening 14.

The tool 10 comprises a main body 18, which has a supporting surface 20, which is suitable for supporting the tool 10 on a surface 22 of one part to be joined 16a. As can be seen from the plan view in FIG. 1, the main body 18 is of U-shaped design. This means that, in a situation in which section 30 of the fastener 12 is projecting beyond the through opening 14 or beyond the surface 22, the main body 18 (or the entire tool 10) can nevertheless be inserted laterally (in the direction of arrow 19 in FIG. 1).

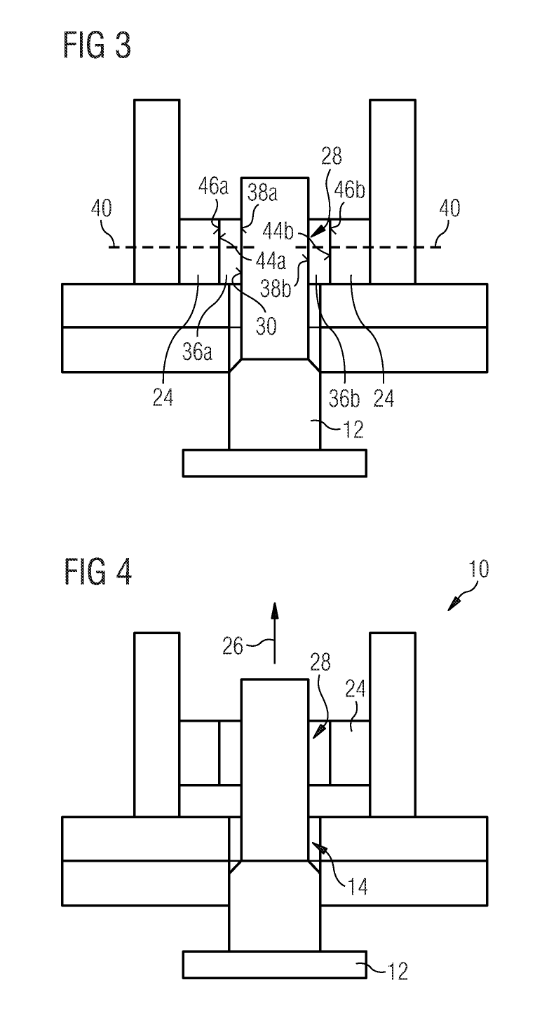

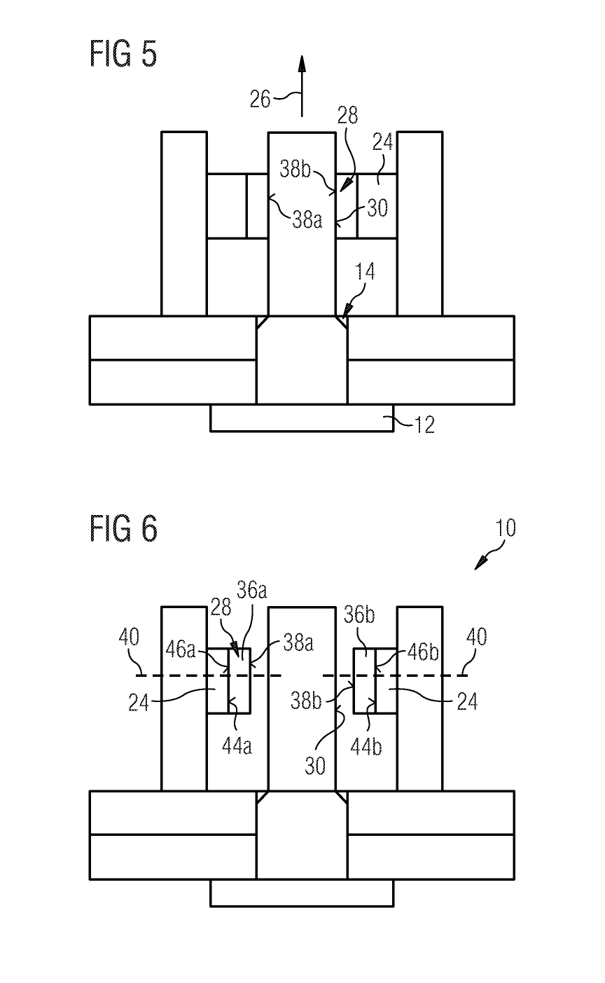

The tool 10 furthermore comprises a pulling body 24, which is suitable for moving the fastener 12 relative to the main body 18. When the main body 18 is resting on the parts 16a, 16b to be joined and the pulling body 24 moves the fastener 12 relative to the main body 18, the fastener 12 is also moved relative to the parts to be joined 16a, 16b or pulled into the through opening 14. The pulling body 24 can be moved relative to the main body 18 in a pulling direction 26 perpendicular to the supporting surface 20 from a first position (illustrated in FIGS. 2 and 3) into a second position (illustrated in FIGS. 5 and 6).

The tool 10 furthermore comprises a clamping device 28, formed on the pulling body 24, which is suitable for clamping the outer section 30 of the fastener 12, which projects beyond the through opening 14 in one part to be joined 16a, 16b.

The extent 32 of the main body 18 perpendicular to the supporting surface 20 is shorter than four times the clamping clearance 34 of the clamping device 28. In the figures, the clamping clearance 34 corresponds substantially to the diameter D of the outer section 30 of the fastener 12. Thus, the tool 10 can also be used in areas to which access is limited (i.e., in spatially restricted areas). A path of movement of the pulling body 24 is also shorter than four times the clamping clearance 34 of the clamping device 28. The limitation of the path of movement likewise allows working or use of the tool 10 in spatially restricted areas.

The clamping device 28 comprises two clamping elements 36a, 36b, each having a clamping surface 38a, 38b for resting on the outer section 30 of the fastener 12. The clamping elements 36a, 36b are mounted in such a way as to be movable towards one another and away from one another in a plane 40 extending parallel to the supporting surface 20 of the main body 18.

To accommodate the outer section 30 of the fastener 12, the pulling body 24 has a unilaterally open recess 42 with two mutually opposite flanks 44a, 44b. The flanks 44a, 44b extend obliquely or in a V shape to one another (to a certain extent like an upside-down V in FIG. 1).

The two clamping elements 36a, 36b are connected integrally to one another or are formed integrally and are at least in part elastically deformable. Furthermore, the two clamping elements 36a, 36b each have a contact side 46a, 46b. The contact sides 46a, 46b of the clamping elements 36a, 36b serve to rest on one of the two flanks 44a, 44b of the pulling body 24 and allow a sliding relative movement between the flanks 44a, 44b and the contact sides 46a, 46b. The clamping surfaces 38a, 38b are formed on opposite inner sides of the clamping elements 36a, 36b, wherein the clamping surfaces 38a, 38b extend parallel to one another.

In order to bring the tool 10, the parts to be joined 16a, 16b and the fastener 12 into the position illustrated in FIG. 2, the two parts to be joined 16a, 16b were first of all positioned in such a way relative to one another in a first step that the through opening 14 was formed. The tool 10 was then placed, by way of the supporting surface 20, on the surface 22 of the part to be joined 16a, and the fastener 12 was pushed partially through the through opening 14, with the result that the outer section 30 projects beyond the part to be joined 16a.

In the situation illustrated in FIG. 2, the pulling body 24 and the clamping device 28 are arranged in the first (lower) position, wherein the two clamping elements 36a, 36b of the clamping device 28 have been displaced relative to the flanks 44a, 44b of the pulling body 24 in such a way that the parallel clamping surfaces 38a, 38b do not touch the outer section 30 of the fastener 12 but are spaced apart therefrom.

FIG. 3 illustrates a situation in which, although the pulling body 24 and the clamping device 28 are still arranged in the first, lower position, the two clamping elements 36a, 36b of the clamping device 28 have been displaced relative to the flanks 44a, 44b of the pulling body 24 in such a way that the parallel clamping surfaces 38a, 38b touch the outer section 30 of the fastener 12 or rest against the outer section 30 and thus clamp the fastener 12. In the plan view, this situation corresponds to the clamping in the situation illustrated in FIG. 1.

In order to clamp the fastener 12 by means of the clamping device 28, the clamping device 28 or clamping elements 36a, 36b was/were moved relative to the pulling body 24 in the plane 40 in such a way that the flanks 44a, 44b and the contact sides 46a, 46b slid along one another and, as a consequence, the clamping surfaces 38a, 38b were moved towards one another until they rested against the outer section 30. In this case, it is possible, for example, to pull on a connection point 37 (cf. FIG. 1) of the two elastic clamping elements 36a, 36b, in the plane 40 extending parallel to the supporting surface 20 (in a direction of arrow 39, cf. FIG. 1), with the result that the contact sides 46a, 46b of the clamping elements 36a, 36b are displaced along the flanks 44a, 44b of the pulling body 24. Owing to the V-shaped arrangement of the flanks 44a, 44b, this then has the effect that the parallel clamping surfaces 38a, 38b formed on the inner sides of the clamping elements 36a, 36b come together or move towards one another.

FIG. 4 illustrates a situation in which the fastener 12 clamped by the tool 10 or the clamping device 28 is moved or pulled in in pulling direction 26. For this purpose, the fastener 12 is pulled to an increasing extent into the through opening 14. The situation illustrated in FIG. 4 to some extent represents an intermediate situation of the pull-in process, in which the fastener 12 has not yet been pulled completely into the through opening 14. During the pull-in or moving process from the first, lower position (cf. FIGS. 2 and 3) of the pulling body 24 or clamping device 28 into the second, upper position (cf. FIGS. 5 and 6), there is no relative movement between the clamping device 28 and the fastener 12 and also no relative movement between the clamping device 28 and the pulling body 24.

FIG. 5 shows a situation in which the fastener 12, together with the pulling body 24, and the clamping device 28 that clamps the fastener 12 have been moved further upwards in pulling direction 26 as far as the second position. The fastener 12 has thus been pulled completely into the through opening 14. The clamping surfaces 38a, 38b continue to rest on the outer section 30 of the fastener 12 and thus continue to clamp it. A plan view of the tool 10 thus still corresponds to the illustration in FIG. 1.

In FIG. 6, the tool 10 is illustrated in a situation in which, in contrast to FIG. 5, the clamping has been removed, i.e., the clamping surfaces 38a, 38b are once again spaced apart from the outer section 30. In order to get into this situation, the clamping process described with reference to FIG. 3 has been carried out in the reverse sequence. That is to say that the clamping device 28 or clamping elements 36a, 36b was/were moved relative to the pulling body 24 in the plane 40 in such a way that the flanks 44a, 44b and the contact sides 46a, 46b slid along one another and, as a consequence, the clamping surfaces 38a, 38b were moved away from one another. In other words, pressing on the connection point 37 in the direction of arrow 41 (cf. FIG. 1) has the effect that the contact sides 46a, 46b of the clamping elements 36a, 36b are pushed along the flanks 44a, 44b of the pulling body 24 in the opposite direction, this in turn having the effect of moving apart the clamping surfaces 38a, 38b arranged parallel to one another.

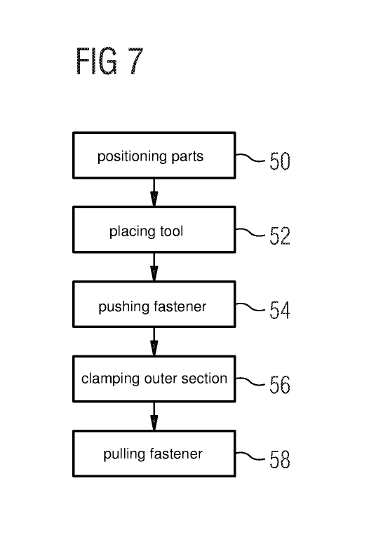

Finally, FIG. 7 shows a method for pulling the fastener 12 into the through opening 14 by means of the tool 10. In a first step 50, the two parts to be joined 16a, 16b are positioned relative to one another in such a way that the through opening 14 is formed. In a second step 52, the tool 10 is then placed on a surface 22 of a part to be joined 16a, 16b by way of the supporting surface 20. In a further step 54, the fastener 12 is then pushed at least partially through the through opening 14. In a further step 56, the outer section 30 of the fastener 12, which projects beyond the through opening 14 in one part to be joined 16a, 16b, is clamped by means of the clamping device 28 (cf. FIGS. 2 and 3) and, finally, in a final step 58, the fastener 12 is pulled completely into the through opening 14 by moving the pulling body 24 (cf. FIGS. 3 to 5). The sequence of FIGS. 3 to 5 shows the process of pulling the fastener 12 into the through opening 14. After the pull-in process, the clamping can be released again (cf. FIGS. 5 and 6) and the tool 10 can be removed from the parts to be joined 16a, 16b, thus enabling the joint to be established.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tool for pulling a fastener into a through opening formed in at least two superposed parts to be joined, comprising:
a main body comprising a supporting surface for supporting the tool on a surface of one part to be joined, and
a pulling body configured to move the fastener relative to the main body,
wherein the pulling body is movable from a first into a second position relative to the main body in a pulling direction perpendicular to the supporting surface, and
a clamping device, formed on the pulling body, configured to clamp an outer section of the fastener, which projects beyond the opening in one part to be joined,
wherein an extent of the main body perpendicular to the supporting surface, and a path of movement of the pulling body, are shorter than four times a clamping clearance of the clamping device.

2. The tool according to claim 1, wherein the clamping device comprises a clamping element having a clamping surface configured to rest on the outer section of the fastener, wherein the clamping element is mounted so as to be movable relative to the pulling body in a plane extending parallel to the supporting surface of the main body.

3. The tool according to claim 1, wherein the clamping device comprises two clamping elements, each having a clamping surface configured to rest on the outer section of the fastener, wherein the clamping elements are mounted so as to be movable towards one another and away from one another in a plane extending parallel to the supporting surface of the main body.

4. The tool according to claim 3,
wherein, to accommodate the outer section of the fastener, the pulling body has a unilaterally open recess with two mutually opposite flanks extending obliquely to one another in a V shape,
wherein the two clamping elements each have a contact side for resting on one of the two flanks, and are connected integrally to one another and are configured so as to be, at least in part, elastically deformable relative to one another, and
wherein the clamping surfaces are formed parallel to one another on opposite inner sides of the clamping elements.

5. The tool according to claim 3, wherein the pulling body is hydraulically movable relative to the main body, and the clamping elements are hydraulically movable relative to the pulling body.

6. The tool according to claim 3, wherein the pulling body is pneumatically movable relative to the main body, and the clamping elements are pneumatically movable relative to the pulling body.

7. The tool according to claim 3, wherein the pulling body is electrically movable relative to the main body, and the clamping elements are electrically movable relative to the pulling body.

8. The tool according to claim 1, wherein the main body and the pulling body and the clamping device are of U-shaped configuration.

9. The tool according to claim 1, wherein an extent of the main body perpendicular to the supporting surface, and the path of movement of the pulling body are shorter than four times the clamping clearance and longer than twice the clamping clearance.

10. A method for pulling a fastener into a through opening by means of a tool according to claim 1, comprising the following steps:
positioning the at least two parts to be joined relative to one another in such a way that the through opening is formed,
placing the tool on a surface of one part to be joined by way of the supporting surface,
pushing the fastener at least partially through the through opening,
clamping an outer section of the fastener, which projects beyond the through opening in one part to be joined, by means of the clamping device,
pulling the fastener in by moving the pulling body.
